(19) United States
(12) Patent Application Publication
(10) Pub. No.: US 2012/0250343 A1
(43) Pub. Date: Oct. 4, 2012

(54) Vehicular Lamp

(75) Inventor: Hiroya KOIZUMI, Shizuoka (JP)

(73) Assignee: KOITO MANUFACTURING CO., LTD., Tokyo (JP)

(21) Appl. No.: 13/430,379

(22) Filed: Mar. 26, 2012

(30) Foreign Application Priority Data
Mar. 31, 2011 (JP) 2011-079434

(51) Int. Cl. F21V 13/02

(52) U.S. Cl. 362/511

(57) ABSTRACT

A vehicular lamp including a plurality of first semiconductor light emitting elements and a plurality of first light guide portions respectively corresponding to the first semiconductor light emitting elements, so that first emission light emitted from the first semiconductor light emitting elements enters the first light guide portions. Second emission light emitted from the first semiconductor light emitting elements but does not enter the first light guide portions is reflected in a radiation direction of the lamp by respective segmented reflecting portions. The first light guide portions are provided spacedly in a first direction that intersects the radiation direction and configured such that the first emission light entering therein is guided in the radiation direction. The segmented reflecting portions are configured such that at least a portion of the reflected second emission light passes therethrough and radiates from an area between the plurality of first light guide portions.

### BACKGROUND OF THE INVENTION

1. Field of the Invention

The present invention relates to a vehicular lamp.

2. Description of the Related Art

Based on automotive design demands, vehicular lamps with novel light emitting surfaces have been proposed for marker lamps, such as tail lamps and turn signal lamps in particular. The development of vehicular lamps that use semiconductor light emitting elements such as light emitting diodes (LEDs) has also been advancing in recent years.

A known example of such a vehicular lamp having a novel light emitting surface includes, as disclosed in the Japanese Patent Application Laid-Open (Kokai) No. 2008-10227, a light emitting element; a reflector that has a reflective surface for reflecting light emitted from the light emitting element forward of the lamp; and a plate-like light guide which is disposed on the front side of the reflector and to which the light emitted from the light emitting element enters from its one side surface and exits forward from the other side surface. In this vehicular lamp, light that is emitted from the light emitting element and near the optical axis of the light emitting element enters the light guide, and light that is emitted from the light emitting element and but is not near the optical axis is projected onto the reflective surface of the reflector. This lamp is thus called to provide a novel design.

However, in the vehicular lamp described above, a plurality of light emitting elements are provided at positions staggered in the vehicle width direction and in the vehicle longitudinal direction. This complicates the shapes of the parts such as a substrate on which the light emitting diodes are mounted, and therefore, there is a room for improvement in the assembly of the substrate and the light emitting diodes.

### BRIEF SUMMARY OF THE INVENTION

The present invention was devised in light of the foregoing circumstances, and it is an object of the present invention to provide a new vehicular lamp that achieves a novel design by using a semiconductor light

To solve the problem described above, the vehicular lamp according to one aspect of the present invention includes:
a plurality of first semiconductor light emitting elements disposed in a spaced manner;
a plurality of light guide portions which respectively correspond to the plurality of first semiconductor light emitting elements and to which first emission light that is emitted from the first semiconductor light emitting elements enters; and
a first reflecting portion that reflects second emission light, which is emitted from the first semiconductor light emitting elements but does not enter the light guide portions, toward the radiation direction of the lamp, and in this structure,
the plurality of light guide portions are each provided spacedly in a first direction that intersects the radiation direction and configured such that the first emission light entering therein is guided toward the radiation direction, and the first reflecting portion is configured such that at least a portion of the reflected second emission light passes therethrough and radiates from the area between the plurality of light guide portions.

In the vehicular lamp of the present invention described above, the plurality of light guide portions are luminous by the first emission light, and at least a portion of the second emission light is radiated from the area between the plurality of light guide portions. Accordingly, when this vehicular lamp is viewed from the front, it appears as if the plurality of light guide portions and the area therebetween are luminous in different ways, thus providing a design (or appearance) that is new to vehicular lamp.

The vehicular lamp of the present invention may further include a single substrate that has a surface on which the plurality of first semiconductor light emitting elements are mounted. These first semiconductor light emitting elements may each be disposed such that the center axis of a light emitting surface of each of them corresponds to a second direction that substantially vertically intersects the radiation direction and the first direction, and the first emission light may include light that is on the center axis of the light emitting surface of the first semiconductor light emitting element. The plurality of light guide portions may each include therein an internal reflecting portion that internally reflects, in the radiation direction, the first emission light entering therein. With these structures, the substrate having thereon the plurality of first semiconductor light emitting elements can be used in common for all the plurality of first semiconductor light emitting elements, and a space for disposing the first semiconductor light emitting elements and the substrate can be downsized.

The first reflecting portion may include a reflective surface that is disposed rearward (or in the back) of the internal reflecting portion in the radiation direction and follows the shape of the internal reflecting portion of the light guide portions. Thus, the first reflecting portion and the internal reflecting portion of the light guide portion can be placed close together, which shortens the depth (or the length in the radiation direction) of the vehicular lamp.

The vehicular lamp of the present invention may further include: second semiconductor light emitting elements that are disposed more rearward than (or in the back of) the first semiconductor light emitting elements in the radiation direction; and a second reflecting portion that reflects, in the radiation direction, third emission light that is emitted from the second semiconductor light emitting elements. Each of the light guide portions may include an incident portion through which at least a portion of the third emission light reflected by the second reflecting portion enters and may be configured such that the light entering from the incident portion is guided in the radiation direction. Thus, any desirable light distribution pattern can be easily set.

The second reflecting portion may be disposed more rearward than the first reflecting portion in the radiation direction, and the first reflecting portion may include a cutout portion that is formed so as to enable at least a portion of the third emission light that is reflected by the second reflecting portion to enter into the light guide portion through its incident portion. Thus, even if the second reflecting portion and the first reflecting portion are disposed overlapping spacedly in the radiation direction, at least a portion of the third emission light reflected by the second reflecting portion can enter the light guide portion.

As seen from the above, according to the present invention, a new vehicular lamp that achieves a novel design (or illuminating appearance) using a semiconductor light emitting element as a light source can be provided.

### BRIEF DESCRIPTION OF THE SEVERAL VIEWS OF THE DRAWINGS

FIG. 1 is a perspective view of a vehicular lamp according to an embodiment of the present invention.

FIG. 2 is a transparent perspective view of a light guide unit used in the present invention.

FIG. 3 is a perspective view of a case unit used in the present invention.

FIG. 4 is a frontal view of a first reflector used in the present invention as viewed from a direction A indicated in FIG. 3.

FIG. 5 is a frontal view of a second reflector used in the present invention as viewed from a direction B indicated in FIG. 3.

FIG. 6 is a side view of a cross section taken along the line 6-6 in FIG. 1 as viewed from the side.

FIG. 7 is a light diagram of a first semiconductor light emitting element used in the present invention shown in cross section taken along the line 7-7 in FIG. 1.

FIG. 8 is a light diagram of a second semiconductor light emitting element used in the present invention shown in cross section taken along the line 8-8 in FIG. 1.

### DETAILED DESCRIPTION OF THE INVENTION

Hereinafter, a mode for carrying out the present invention will be described in detail with reference to the accompanying drawings. Like reference numerals are used for like or corresponding structural elements, members, and processes shown in the drawings, and duplicate descriptions are omitted as appropriate. The embodiments are not intended to limit the invention but are to exemplify the invention. All of the features and the combinations thereof described in the embodiments are not necessarily essential to the invention.

A vehicular lamp described below is a lamp that has the functions of both a day running lamp (DRL) and a clearance lamp (CLL), and the vehicular lamp according to the present invention is not limited to this combination of functions and may include the functions of a tail lamp and a stop lamp, for example.

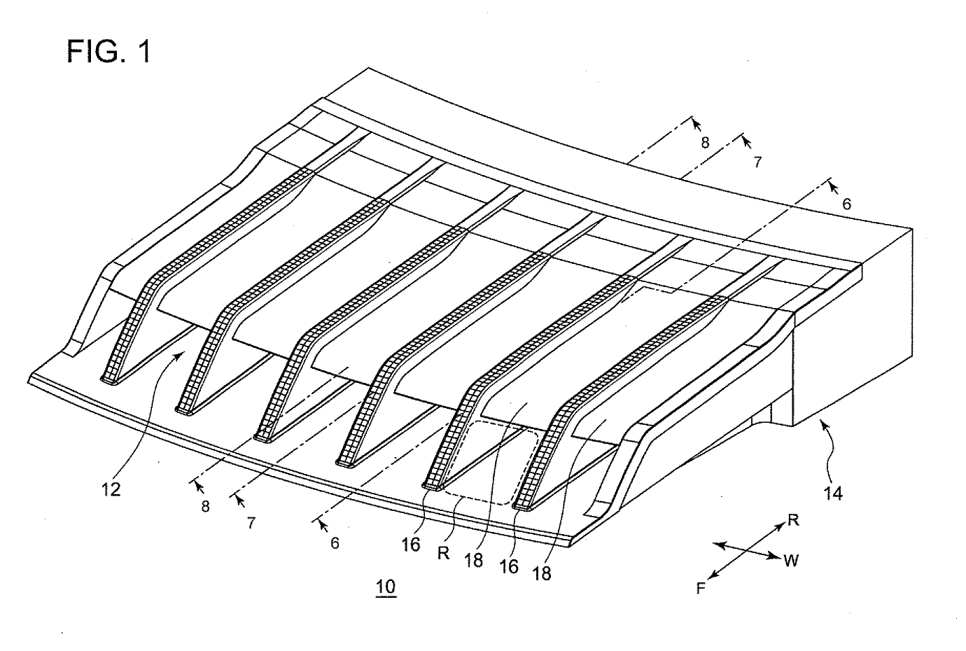

FIG. 1 is a perspective view of a vehicular lamp according to one embodiment of the present invention. It should be noted that, in the following description, for convenience, the arrow F indicates the forward (in view of the advancement of the emitted light) direction, the arrow R indicates the rearward (or opposite to the forward) direction, and the arrow W indicates the vehicle width direction in FIG. 1. However, the directions noted here are relative and the layout of the actual vehicular lamp is not necessarily limited to these directions.

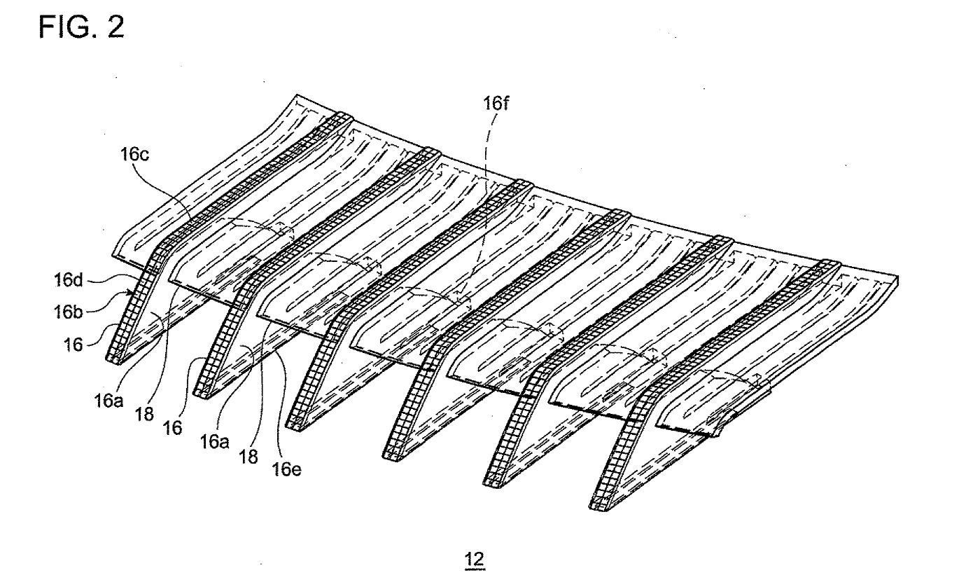

A vehicular lamp 10 according to the shown embodiment includes a light guide unit 12 and a case unit 14. FIG. 2 is a transparent perspective view of the light guide unit. As shown in FIG. 2, the light guide unit 12 includes a plurality of plate-like first light guide units 16 that are disposed in a laterally spaced manner, and a plurality of plate-like second light guide portions 18 that connect pairs of adjacent first light guide portions 16. Both ends of each second light guide portion 18 are connected to the side surfaces 16a of the first light guide portions 16. The first light guide portions 16 and the second light guide portions 18 are each formed by a colorless, transparent resin shaped as a plate with a required thickness.

The first light guide portions 16 each have a front surface 16b that is inclined when viewed form the side or in the direction of W, and a plurality of projecting portions 16d are formed in a regularly-arranged pattern on the top surfaces of the front surface 16b and on the upper surface 16c. The projecting portions 16d diffuse and emit light that is outwardly radiated after passing through the inside of the first light guide portions 16.

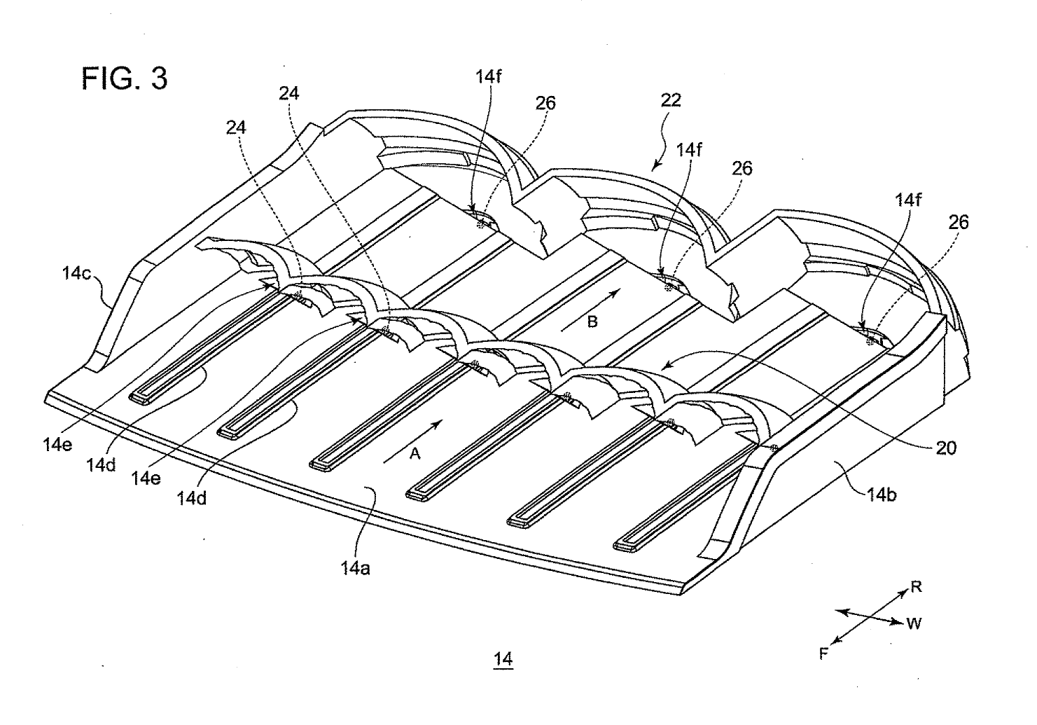

FIG. 3 is a perspective view of the case unit 14. The case unit 14 includes a bottom plate 14a, side walls 14b, 14c, and a first reflector (or first reflecting portion) 20 and a second reflector (second reflecting portion) 22 are provided on the bottom plate 14a. The first reflector 20 is disposed more forward than the second reflector 22, and it has a horizontally or laterally long shape that overlaps spacedly with a lower portion of the second reflector 22 when viewed from the front. A positioning portion 14d that fixes and positions the bottom portion 16e of each first light guide portion 16 (see FIG. 2) is formed at six spacedly separated locations on the bottom plate 14a. The positioning portions 14d are each formed such that its lengthwise direction is substantially parallel to the front-rear direction of the vehicular lamp 10.

A first opening portion 14e is formed in the bottom plate 14a so as to be under the first reflector 20 and in the rear portion of the respective positioning portions 14d (thus a total of six (6) first opening portions 14e are formed in the bottom plate 14a (so as to correspond to the six (6) first light guide portions 16)). First semiconductor light emitting elements 24 are respectively disposed in a laterally spaced manner under the six (6) locations where the first opening portions 14e are formed. The plurality of (or six) first semiconductor light emitting elements 24 are mounted on a single substrate described later.

Furthermore, a second opening portion 14f is formed in the bottom plate 14a so as to be under the second reflector 22 and at each of three laterally separated locations of the bottom plate 14a. Second semiconductor light emitting elements 26 are respectively disposed in a laterally spaced manner under the three (3) locations where the second opening portions 14f are formed. The plurality of (or 3) second semiconductor light emitting elements 26 are mounted on a single substrate described later.

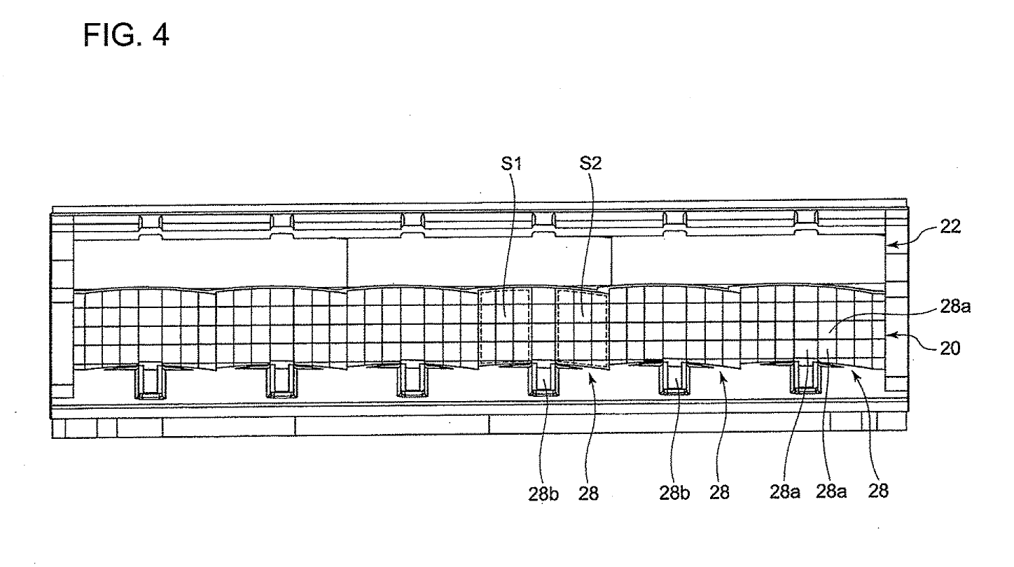

FIG. 4 is a frontal view of the first reflector 20 as viewed from the direction A indicated in FIG. 3. The first reflector 20 is configured from a plurality of segmented reflecting portions 28, six in the shown embodiment, arranged in a row along the vehicle width direction W. The six segmented reflecting portions 28 together thus configure the first reflector 20. The outer surface of each segmented reflecting portion 28 is subjected to a surface treatment such as aluminum deposition or coating, so that it is configured as a mirror surface that reflects light. Each segmented reflecting portion 28 also includes a plurality of sub-segments 28a. Each of the plurality of sub-segments 28a is formed as a smooth curved surface, and adjacent sub-segments whose edges contact each other are connected through a step or fold. A cutout portion (opening portion) 28b is formed in the center lower portion of each segmented reflecting portion 28 of the first reflector 20.

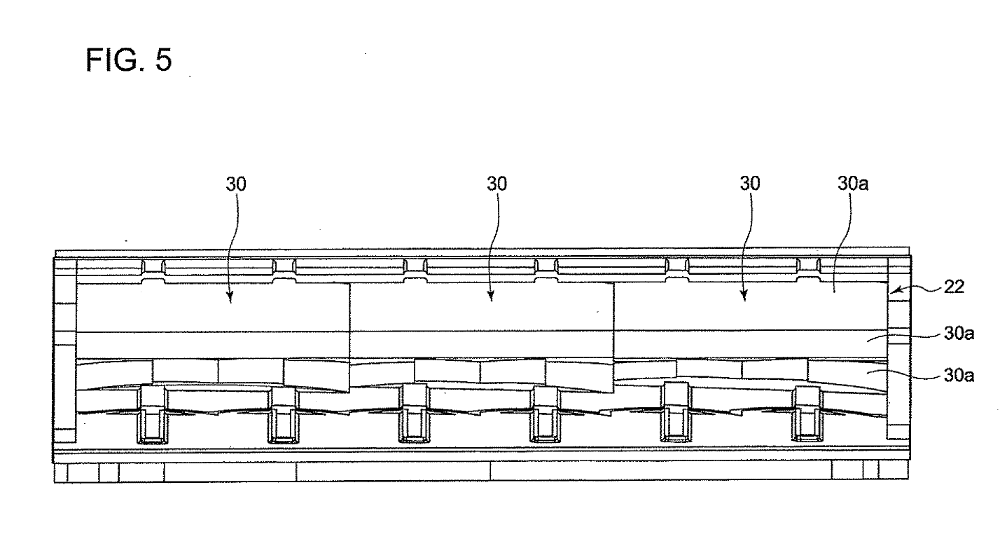

FIG. 5 is a frontal view of the second reflector 22 as viewed from the direction B indicated in FIG. 3. The second reflector 22 is configured from a plurality of segmented reflecting portions 30, three in the shown embodiment, arranged in a row along the vehicle width direction W. The three segmented reflecting portions 30 together thus configure the second reflector 22. The outer surface of each segmented reflecting portion 30 is subjected to a surface treatment such as aluminum deposition or coating, so that it is configured as a mirror surface that reflects light. Each segmented reflecting portion 30 also includes a plurality of sub-segments 30a. Each of the plurality of sub-segments 30a is formed as a smooth curved surface, and adjacent sub-segments whose edges contact each other are connected through a step or fold.

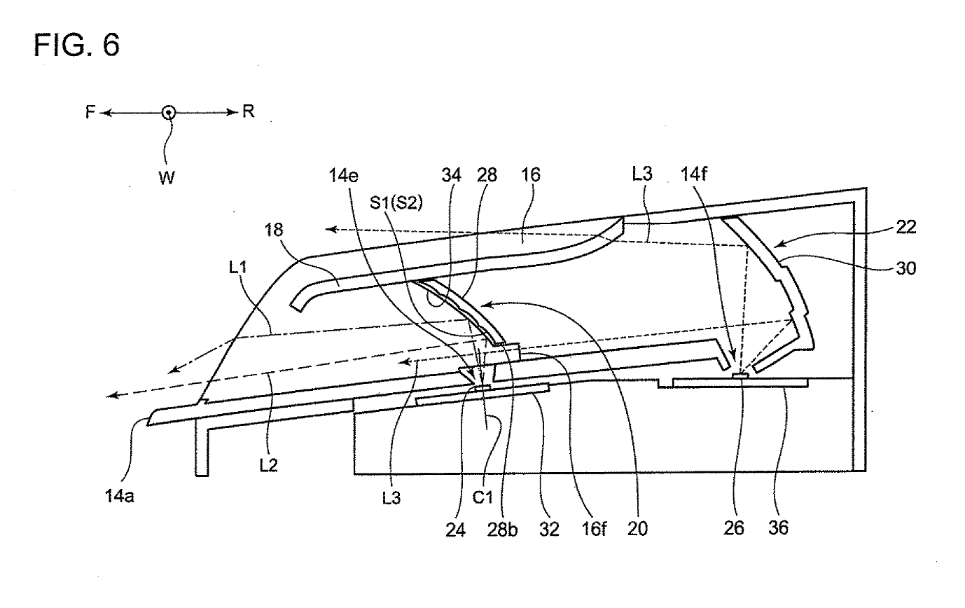

FIG. 6 is a side view of a cross section taken along the line 6-6 in FIG. 1 as viewed from the side. It should be noted that though FIG. 6 shows one first light guide portion 16, in the vehicular lamp 10 according to the shown embodiment, as shown in FIG. 2, a plurality of (or 6) first light guide portions 16 are provided in a spaced manner respectively corresponding to the plurality of (or 6) first semiconductor light emitting elements 24. For convenience, the following description will focus on one of the first light guide portions 16 only and members corresponding thereto.

First emission light L1 that is emitted from the first semiconductor light emitting element 24, which is disposed under the first light guide portion 16, enters the first light guide portion 16. As descried above, the first light guide portions 16 are provided in a plurality of numbers so that they are spaced in a first direction (direction indicated by the arrow W in FIG. 3) that intersects a radiation direction (direction indicated by the arrow F in FIG. 3), and they are configured such that the first emission light L1 entering therein is guided toward the radiation direction F.

Second emission light L2 that is emitted from the first semiconductor light emitting element 24 but does not enter the first light guide portion 16 is reflected in the radiation direction by the corresponding segmented reflecting portion 28 of the first reflector 20. The segmented reflecting portions 28 that function as a first reflecting portion are configured such that at least a portion of the reflected second emission light L2 passes through and radiates from an area (area R shown in FIG. 1) between the plurality of first light guide portions 16. In other words, the second emission light L2 is mainly the light emitted at an angle into or up out of the drawing sheet for FIG. 6 from the first semiconductor light emitting element 24, and it is also the light reflected at reflective areas S1, S2 (see FIG. 4) on both sides of the segmented reflecting portion 28 other than its center portion.

As seen from the above description, in the vehicular lamp 10 according to the shown embodiment, the plurality of first light guide portions 16 are luminous due to the first emission light L1, and at least a portion of the second emission light L2 is radiated from the areas R between the plurality of first light guide portions 16. Accordingly, when the vehicular lamp 10 is viewed from the front, it appears as if the plurality of first light guide portions 16 and the areas R therebetween are luminous in different ways, thus providing a new design of an illuminating vehicular lump.

The first semiconductor light emitting element 24 is disposed such that the center axis C1 of its light emitting surface is aligned with a second direction that longitudinally intersects the radiation direction (direction of the arrow F) and the first direction (direction indicated by the arrow W in FIG. 3) (the center axis C1 thus being substantially vertical). The first emission light L1 of the first semiconductor light emitting element 24 includes light on the center axis of the light emitting surface of the first semiconductor light emitting element 24. In addition, the first light guide portion 16 includes an internal reflecting portion 34 that is formed therein and internally reflects (wholly reflects) the first emission light L1 entering therein in the radiation direction. The plurality of (six) first semiconductor light emitting elements 24 are mounted at regular intervals horizontally or laterally on the same surface of a single first substrate 32 shown in FIG. 6. Thus, the substrate mounted with the plurality of first semiconductor light emitting elements 24 can be used in common for all of the plurality of first light guide portions 16, which simplifies a mounting process related to mounting of the semiconductor light emitting elements 24. In addition, a space for disposing the first semiconductor light emitting elements 24 and the first substrate 32 can be downsized and made thinner (space can be saved).

The segmented reflecting portion 28 of the first reflector 20 includes the reflective surface that is positioned rearward of (or in the back) the internal reflecting portion 34 in the radiation direction and follows the shape of the internal reflecting portion 34. In other words, the internal reflecting portion 34 of the first light guide portion 16 is provided so as to follow the outer surface of the corresponding segmented reflecting portion 28 of the first reflector 20. Thus, the segmented reflecting portion 28 and the internal reflecting portion 34 of the first light guide portion 16 can be placed close together, which shortens the depth (in the front-rear direction) of the vehicular lamp 10.

The vehicular lamp 10 according to the shown embodiment described above further includes, as described above, the second semiconductor light emitting elements 26 that are disposed more rearward than the first semiconductor light emitting elements 24 in the radiation direction, and it also includes the segmented reflecting portions 30 of the second reflecting portion, and this second reflecting portion reflects third emission light L3 that is emitted from the second semiconductor light emitting elements 26 in the radiation direction. Each of the first light guide portions 16 includes an incident portion 16f (see FIG. 2), to which at least a portion of the third emission light L3 reflected by the segmented reflecting portions 30 enters, and is configured such that the light entering the incident portion 16f is guided toward the radiation direction. Thus, any light distribution pattern can be easily set by controlling the lighting of the first semiconductor light emitting elements 24 and/or the second semiconductor light emitting elements 26.

It should be noted that the plurality of second semiconductor light emitting elements 26 are mounted at regular lateral intervals on the same surface of a single second substrate 36 shown in FIG. 6. Thus, the substrate mounted with the plurality of second semiconductor light emitting elements 26 can be used in common for all of the plurality of segmented reflecting portions 30, which simplifies a mounting process related to mounting of the second semiconductor light emitting elements 26. In addition, a space for disposing the second semiconductor light emitting elements 26 and the second substrate 36 can be downsized and made thinner (space can be saved).

The segmented reflecting portions 30 of the second reflector 22 are disposed more rearward than the segmented reflecting portions 28 of the first reflector 20 in the radiation direction. The segmented reflecting portions 28 each include a cutout portion 28b that is formed so as to enable at least a portion of the third emission light L3 reflected by the corresponding segmented reflecting portion 30 to enter from the incident portion 16f of the first light guide portions 16. Thus, even if the segmented reflecting portions 30 of the second reflector 22 and the segmented reflecting portions 28 of the first reflector 20 are disposed overlapping when viewed from the front as shown in FIG. 4, at least a portion of the third emission light L3 reflected by the segmented reflecting portions 30 can enter the first light guide portions 16. In other words, the light emitted from the second semiconductor light emitting elements 26 can be more effectively utilized for forming a light distribution pattern.

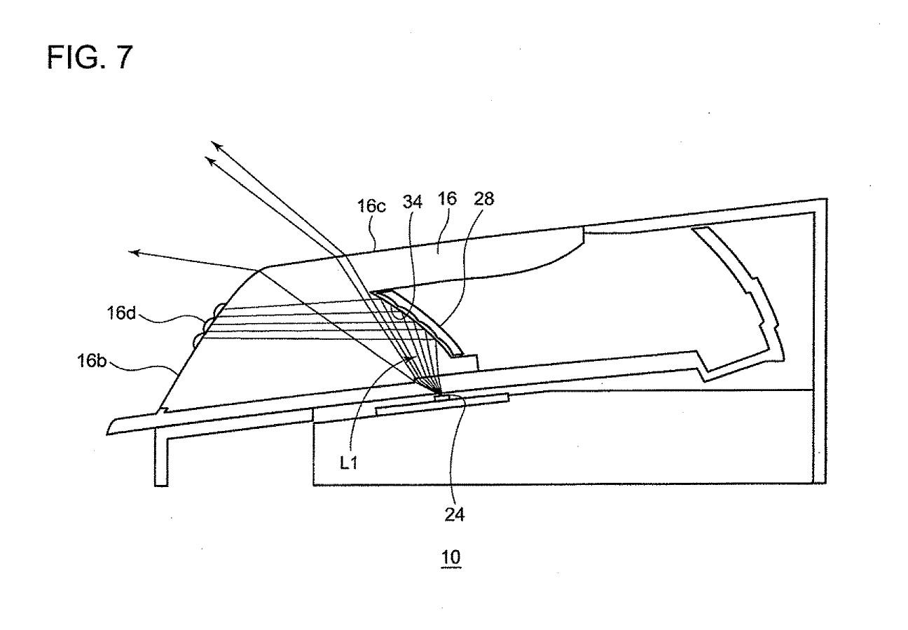

FIG. 7 is a light diagram of the first semiconductor light emitting element 24 in a cross section taken along the line 7-7 in FIG. 1. As shown in FIG. 7, the first emission light L1 that is emitted from the first semiconductor light emitting element 24 and, enters the first light guide portion 16 subsequently passes through the first light guide portion 16 and is entirely reflected by the internal reflecting portion 34 provided in the first light guide portion 16. In addition, a portion of the first emission light L1 passes through the internal reflecting portion 34 and is emitted to the outside of the first light guide portion 16, after which such light is again reflected by the segmented reflecting portion 28 and reenters the first light guide portion 16. Thus, the front surface 16b and the upper surface 16c of the first light guide portion 16 both appear to emit light. The first emission light L1 has high luminosity because it includes the center axis C1 (optical axis) of the light emitting surface of the first semiconductor light emitting element 24. In other words, the brightness of the first light guide portion 16 can be emphasized.

Also, in the vehicular lamp 10 of the shown embodiment, light that entered and passed through the first light guide portion 16 and is emitted from the internal reflecting portion 34 reenters the first light guide portion 16 due to the presence of the segmented reflecting portion 28. Therefore, the efficiency with which the light emitted from the first semiconductor light emitting element 24 is utilized as radiated light from the vehicular lamp 10 can be improved.

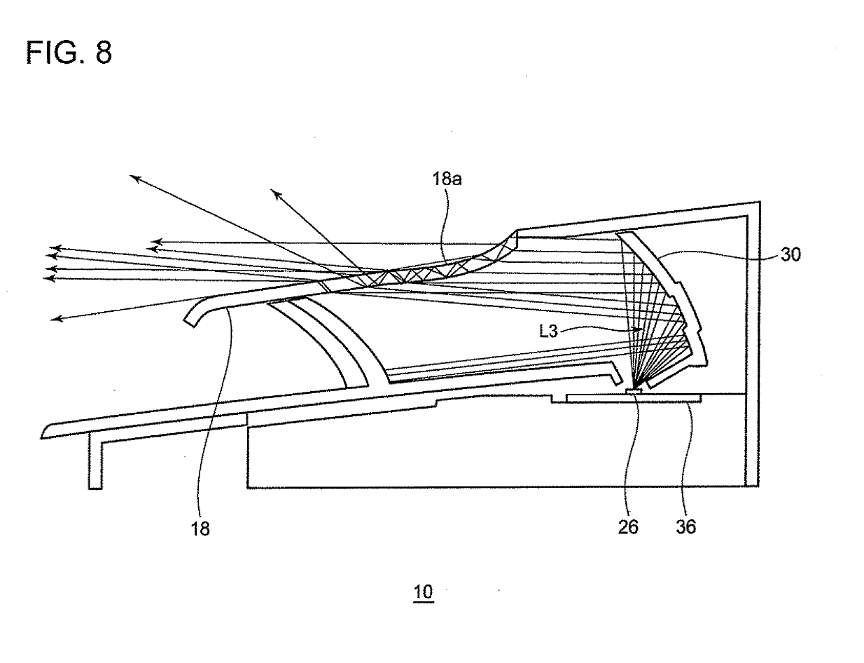

FIG. 8 is a light diagram of the second semiconductor light emitting element 26 in a cross section taken along the line 8-8 in FIG. 1. As shown in FIG. 8, the third emission light L3 that is emitted from the second semiconductor light emitting element 26 and reflected by the segmented reflecting portion 30 is subsequently mainly emitted from the upper surface 18a of the second light guide portion 18 after being repeatedly refracted when passing through the second light guide portion 18 or entirely reflected within the second light guide portion 18. Thus, the upper surface 18a of the second light guide portion 18 appears to emit light.

As described above, the vehicular lamp 10 according to the shown embodiment lights the plurality of first semiconductor light emitting elements 24 to function as, for example, a DRL, so that the front surfaces 16b and the upper surfaces 16c of the first light guide portions 16 can emit light, and at the same time light can also be radiated from the areas R that are between the plurality of first light guide portions 16. In addition, the vehicular lamp 10 according to the shown embodiment lights the plurality of second semiconductor light emitting elements 26 to function as, for example, a CLL, whereby the upper surfaces 18a of the second light guide portions 18 can emit light and the front surfaces 16b of the first light guide portions 16 can also emit light using the third emission light L3 that enters the first light guide portions 16 through its incident portions 16f.

In the present invention, the first semiconductor light emitting elements 24 and the second semiconductor light emitting elements 26 can be selected as appropriate, depending on the required function, from light emitting elements such as white, blue, amber, and/or red LEDs. For example, a white or blue LED is suitable if the first semiconductor light emitting elements 24 are used as the light source of a DRL. Similarly, a white LED is suitable if the second semiconductor light emitting elements 26 are used as the light source of a CLL. Moreover, if the vehicular lamp 10 is used as a tail and stop lamp (T&SL), red and amber LEDs are suitable as the first semiconductor light emitting elements 24 and the second semiconductor light emitting elements 26.

As seen from the above, the vehicular lamp 10 of the present invention can provide a novel design of illuminating vehicular lumps while having different lighting functions by controlling the lighting of the first semiconductor light emitting elements 24 and/or the second semiconductor light emitting elements 26.

In the vehicular lamp 10 according to the shown embodiment, the first light guide portion 16 and the second light guide portion 18 can be formed of a light transmissive resin that is colored by the same color system as the emission color of the LEDs used.

In addition, the light emitting elements used in the shown embodiment are not limited to LEDs, and other light emitting elements such as electroluminescence (EL), laser diodes (LD) can be used. Moreover, the vehicular lamp 10 according to the shown embodiment is not limited to a DRL or a CLL, and it can also be applied to a marker lamp or an auxiliary lamp that uses a light emitting element as the light source.

In the description above, the term “forward” refers to the radiation direction of light and is not necessarily based on the front and rear of a vehicle. In other words, if the vehicular lamp 10 is used as a tail and stop lamp (T&SL), the vehicle rearward direction is the “forward”.

The present invention is described above with reference to an embodiment. However, the present invention is not limited to the above embodiment, and examples that suitably combine and/or substitute the constitution of the embodiment are also included in the present invention. In addition, various modifications such as suitable changes to the combination and process sequence of the embodiment and design changes based on the knowledge of persons having ordinary skill in the art can be added to the embodiment, and embodiments with such added modifications are also included in the scope of the present invention.

1. A vehicular lamp comprising:
a plurality of first semiconductor light emitting elements disposed in a spaced manner;
a plurality of light guide portions which respectively correspond to the plurality of first semiconductor light emitting elements, and to which first emission light that is emitted from the first semiconductor light emitting elements enters; and
a first reflecting portion for reflecting second emission light, which is emitted from the first semiconductor light emitting elements but does not enter the light guide portions, toward a radiation direction, wherein
the plurality of light guide portions are provided spacedly in a first direction that intersects the radiation direction, and configured such that the first emission light entering therein is guided toward the radiation direction, and
the first reflecting portion is configured such that at least a portion of the reflected second emission light passes therethrough and radiates from an area between the plurality of light guide portions.

2. The vehicular lamp according to claim 1, further comprising:
a substrate that has a surface on which the plurality of first semiconductor light emitting elements are mounted, wherein
the plurality of first semiconductor light emitting elements are each disposed such that a center axis of a light emitting surface thereof corresponds to a second direction that intersects the radiation direction and the first direction,
the first emission light includes light on the center axis of the light emitting surface of each of the first semiconductor light emitting elements, and
the light guide portions each include therein an internal reflecting portion for internally reflecting, in the radiation direction, the first emission light entering.

3. The vehicular lamp according to claim 2, wherein
the first reflecting portion includes a reflective surface that is disposed rearward of the internal reflecting portion in the radiation direction and follows a shape of the internal reflecting portion.

4. The vehicular lamp according to claim 1, further comprising:
a plurality of second semiconductor light emitting elements disposed more rearward than the plurality of first semiconductor light emitting elements in the radiation direction; and
a second reflecting portion that reflects, in the radiation direction, third emission light emitted from the plurality of second semiconductor light emitting elements, wherein
each of the plurality of light guide portions includes an incident portion to which at least a portion of the third emission light reflected by the second reflecting portion enters and is configured such that the light entering from the incident portion is guided toward the radiation direction.

5. The vehicular lamp according to claim 4, wherein
the second reflecting portion is disposed more rearward than the first reflecting portion in the radiation direction, and
the first reflecting portion includes a cutout portion formed so as to enable at least a portion of the third emission light reflected by the second reflecting portion to enter from the incident portion.

6. The vehicular lamp according to claim 2, further comprising:
a plurality of second semiconductor light emitting elements disposed more rearward than the plurality of first semiconductor light emitting elements in the radiation direction; and
a second reflecting portion that reflects, in the radiation direction, third emission light emitted from the plurality of second semiconductor light emitting elements, wherein
each of the plurality of light guide portions includes an incident portion to which at least a portion of the third emission light reflected by the second reflecting portion enters and is configured such that the light entering from the incident portion is guided toward the radiation direction.

7. The vehicular lamp according to claim 3, further comprising:
a plurality of second semiconductor light emitting elements disposed more rearward than the plurality of first semiconductor light emitting elements in the radiation direction; and
a second reflecting portion that reflects, in the radiation direction, third emission light emitted from the plurality of second semiconductor light emitting elements, wherein
each of the plurality of light guide portions includes an incident portion to which at least a portion of the third emission light reflected by the second reflecting portion enters and is configured such that the light entering from the incident portion is guided toward the radiation direction.

8. The vehicular lamp according to claim 6, wherein
the second reflecting portion is disposed more rearward than the first reflecting portion in the radiation direction, and
the first reflecting portion includes a cutout portion formed so as to enable at least a portion of the third emission light reflected by the second reflecting portion to enter from the incident portion.

9. The vehicular lamp according to claim 7, wherein
the second reflecting portion is disposed more rearward than the first reflecting portion in the radiation direction, and
the first reflecting portion includes a cutout portion formed so as to enable at least a portion of the third emission light reflected by the second reflecting portion to enter from the incident portion.
